(19) United States
(12) Patent Application Publication
(10) Pub. No.: US 2026/0066760 A1
(43) Pub. Date: Mar. 5, 2026

(54) ENGINE PROPULSION SYSTEM DRIVEN BY MAGNETIC INTERACTIONS

(71) Applicant: Luke C. Amalfitano, Melbourne, FL (US)

(72) Inventor: Luke C. Amalfitano, Melbourne, FL (US)

(21) Appl. No.: 19/320,291

(22) Filed: Sep. 5, 2025

Related U.S. Application Data
(60) Provisional application No. 63/690,990, filed on Sep. 5, 2024.

(51) Int. Cl. H02K 53/00; H02K 7/075; H02K 41/02

(52) U.S. Cl. CPC H02K 53/00; H02K 7/075; H02K 41/02

(57) ABSTRACT

An engine. A movable member is coupled to an output shaft and displaced responsive to a magnetic field that causes rotation of the output shaft. A plurality of replaceable cartridge modules each comprises a plurality of coils for generating the magnetic field when energized. Each cartridge also includes a moveable member. A sensor is configured to provide an output shaft angle. A timing controller is configured to energize each coil within each one of the plurality of cartridge modules; the energization responsive to one or both of the output shaft angle and an external load. Energizing each coil generates the magnetic field at predetermined angular positions of the output shaft. A generator or alternator mechanically coupled to the output shaft generates an electrical output. A power manager partitions the electrical output among an energy storage device, an external load, and energization of the plurality of coils.

### CROSS REFERENCE TO RELATED APPLICATIONS

The present application claims priority under 35 U.S.C. 119(e) to the provisional patent application filed on Sep. 5, 2024 and assigned application number 63/690,990 (Attorney Docket Number 16655-002). The contents of that application are incorporated herein in their entirety.

### FIELD OF THE INVENTION

The present invention relates to an engine propulsion system driven by magnetic interactions between rotating and non-rotating elements.

### BACKGROUND OF THE INVENTION

An electromagnetic engine propulsion system harnesses magnetic forces to achieve efficient rotational motion, significantly advancing traditional engine technologies. The system operates according to Faraday's and Lenz's Laws, thereby eliminating the need for conventional fuel sources and offering near 100% efficiency by utilizing controlled electromagnetic induction effects.

This technology provides a sustainable, cost-effective alternative to internal combustion engines, integrating smoothly into existing systems with reduced environmental impact, lower noise levels, and enhanced thermodynamic efficiency, revolutionizing both vehicle propulsion and power generation systems.

The system can function as a motor driving a generator and/or a generator driving a motor, making it capable of both propulsion and electricity generation. At the highest level, the motor utilizes electromagnetic forces to drive a central shaft, and connected components, and as a generator, the system converts the mechanical energy from the rotating shaft into electrical energy. This dual-purpose capability allows the engine to not only propel vehicles or machinery, but also generate electricity for various applications, making it a highly versatile and sustainable power solution. By integrating this motor-generator approach, the system enhances energy efficiency, enabling on-demand power generation while maintaining propulsion.

Traditional internal combustion engines operate by cycling rotation through phases of fuel intake and gas exhaustion, wherein burned fuel and air are expelled from the piston chamber before a new fuel mixture is injected and ignited. This cyclical process generates significant environmental emissions and is thermodynamically inefficient.

### BRIEF DESCRIPTION OF THE FIGURES

Various other objects, features and attendant advantages of the present invention will become fully appreciated as they become better understood when considered in conjunction with the accompanying drawings, in which like reference characters designate the same or similar parts throughout the several views, and wherein:

FIG. 1 illustrates an internal magnetic engine and associated components according to the teachings of the present invention in block diagram form.

FIG. 2 illustrates a replaceable cartridge for use with the internal magnetic engine of FIG. 1.

FIGS. 3-6 illustrate cross-section views of various embodiments of the replaceable cartridge of FIG. 2.

FIG. 7 illustrates a timing map for energizing multiple replaceable cartridges, such as the cartridge of FIG. 2, showing pulse width, firing angle, and cartridge firing order.

FIG. 8 illustrates commutation of the internal magnetic engine of FIG. 1 versus a conventional brushless direct current engine.

FIG. 9 illustrates a timing diagram for a rotary internal magnetic engine of the present invention over an engine cycle of 720 degrees.

FIG. 10 illustrates a timing diagram for a rotary internal magnetic engine of the present invention over an engine cycle of 360 degrees.

FIGS. 11 and 12 illustrate a single rotor-stator with propulsor, starter/generator, and engine speed control according to the teachings of the present invention.

FIG. 13 illustrates a brushless motor according to the teachings of the present invention.

FIG. 14A. 14B, and 14C illustrates a brushless motor and perspective insets of rotor and stator assemblies.

FIGS. 15A and 15B illustrate a pulley/belt integration with alternator/generator and starter according to the teachings of the present invention.

FIGS. 16A, 16B, and 16C illustrate a multi-stage brushless motor (multiple rotor-stator sections on one shaft) with an engine speed control for coordinating the individual motors.

### DETAILED DESCRIPTION OF THE INVENTION

The engine of the present invention harnesses magnetic forces to achieve rotational RPMs (revolutions per minute) of the center shaft, resulting in nearly zero environmental emissions. The engine operates according to Faraday's Law and Lenz's Law of electromagnetism, achieving high efficiency and eliminates the need for traditional fuel sources. Additionally, the engine's design minimizes entropy and heat loss, distributes applied forces evenly across the system and reduces stress per propulsor RPM. The engine can operate on a traditional small auxiliary battery or powered by a generator, facilitating integration into existing legacy vehicle systems without substantial modifications.

Also, the engine of the present invention provides a reduced noise level far below the noise level of traditional engines. Most LRU-style (line replaceable unit) traditional engines tend to be quite noisy. During development of these engines sometimes the noise is intentionally increased to achieve another desirable objective, while other development efforts reduce the noise. In later developments of combustion engines, it was determined that the noise from the engine represents energy lost. The internal magnetic engine (IME) of the present invention does not “lose energy” that impacts the engine's overall efficiency and performance. While maintaining some audible characteristics of conventional internal combustion engines, the engine (also known as a motor) of the present invention operates at reduced noise levels, addressing consumer concerns about loud engine noise.

The electromagnetic engine is lighter than both contemporary gas and electric engines, improving vehicle efficiency and performance without the weight of traditional fuel systems or large DC batteries.

The electromagnetic engine offers on-demand, unlimited range by driving the center shaft electromagnetically according to Faraday's Law.

The present engine combines the efficiency of electric propulsion with superior sustainability, providing clean energy and eliminating the need for conventional battery cells.

In summary, the engine of the present invention revolutionizes engine technology by combining the strengths of electric and combustion engines, resulting in an ecologically sound, efficient, and cost-effective solution. The internal magnetic engine sets a new standard for sustainable automotive propulsion, offering unparalleled operational range and minimal environmental impact.

### Linear Internal Magnetic Engine

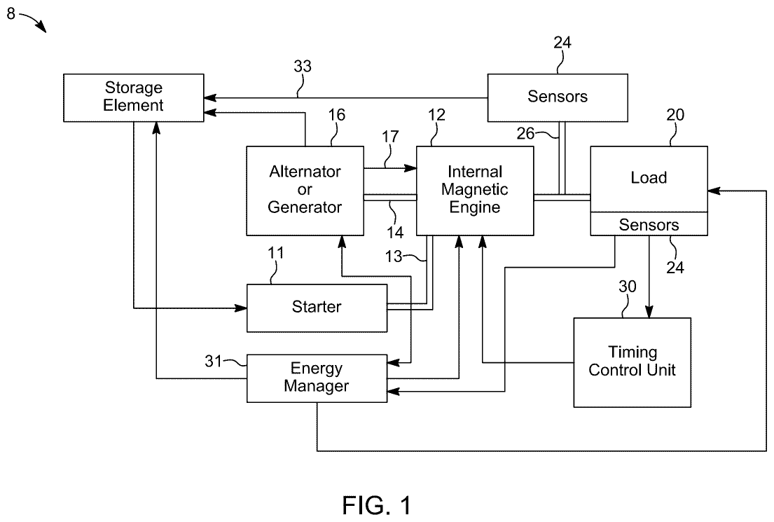

FIG. 1 illustrates a block diagram of an internal magnetic engine 8 and associated components according to the teachings of the present invention. A storage element 10 (comprising a battery or a capacitor) provides initial power to rotate a starter 11. The starter in turn causes rotation of the IME 12 via a shaft 13. Once the IME begins to rotate, an engine shaft 14 turns the alternator/generator 16 for generating electricity, which in turn supplies electricity to the internal magnetic engine 12 over conductor 17. The internal magnetic engine relies on magnetic principles and creation of a magnetic field between a stator and a rotor to create rotational motion. Several examples of the internal magnetic engine are described hereinafter.

The internal magnetic engine 12 supplies energy to a load 20. In one embodiment, the energy is supplied as a rotational force or torque to the load 20. For example, the load may represent the driving wheels of an automotive vehicle.

Sensors 24 indicated as either proximate a rotating shaft 26 (also rotated by the IME 12) or proximate the load 20 provide information to a timing control unit 30 comprising, for example, a central processing unit, an engine speed controller, and/or a pulse width modulating signal unit. Generally, these timing signals (more specifically high current pulses activated by the timing signals) are input to the internal magnetic engine 12 to control excitation of electromagnet coils, i.e., creating a magnetic field that interacts with permanent magnets to turn the IME. The relationship and physical arrangement of the electromagnetic coil and the permanent magnets will be described hereinafter.

The starter 11 may comprise any of the well-known devices for starting a conventional automative engine, including a manual crank, an auxiliary motor powered by the battery or another prime mover powered from an external source.

The alternator/generator 16 is physically coupled to the IME 12 by any of the well-known coupling techniques, including a direct shaft, one or more gears, or a pulley/belt arrangement. The shaft 14 is indicated as the coupling element.

If the alternator/generator 16 generates AC electricity, it is rectified to DC as known by those skilled in the art. The application of electricity from the alternator/generator 16 over the link 17 to the IME 12 (specifically to the rotor or stator of the IME 12) is controlled by control signals produced by the timing control unit 30. Generally, the alternator/generator 16 provides electricity to the IME 12 and is considered the primary supply source. The storage element 10 is considered a secondary source of electricity. One or both of the primary and secondary sources provides electricity to the IME 12 responsive to the RPMS demanded by the load 20.

The IME 12 provides rotary motion to the load 20. The rotary motion is supplied by the IME 12 in a physical arrangement that mimics a conventional automotive engine. Except in the case of the IME, the piston, or a similar component is driven downwardly and/or upwardly by a magnetic force developed between a rotor and a stator. This is unlike the conventional automotive engine where the piston force is supplied by an explosive combustion that ignites a fuel within the piston cylinder. In another embodiment, the IME comprises a concentric rotor and stator, with the rotator rotating responsive to electromagnetic fields that are established in the stator. These embodiments are described in detail below. In the technical description set forth below certain components are referred to as a rotor or a stator. It is known in the art that the rotor component is always that which rotates, while the stator component is stationary. Those terms have been applied to the present invention as described below.

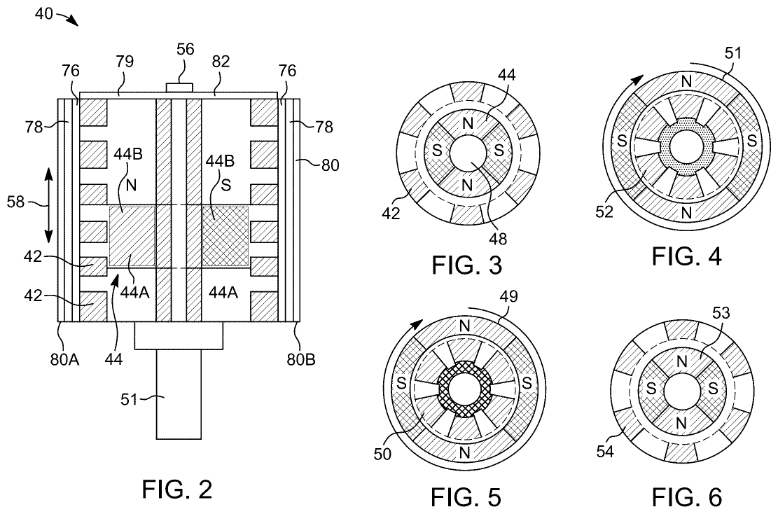

FIG. 2 illustrates a vertical cross section of a so-called cartridge or bayonet 40 cylindrical in shape and comprising a plurality of a vertically mounted or stacked stator coils 42 disposed around the circumference of a cylinder. FIG. 3 illustrates a horizontal cross section of the cartridge or bayonet. As can be seen in FIG. 3 the stator coils extend circumferentially around the circumference of the cylinder.

A rotor 44, in one embodiment comprising one or more permanent magnets 44B. The rotor is configured with permanent magnets of opposite polarity (north and south poles as indicated) on opposing sides of the sleeve 48. This alternating polarity ensures that when the stator coils 42 are energized, they can alternately attract and repel the rotor magnets, producing the intended push-pull impulse effect.

The permanent magnets 44B are attached to an upper surface of a piston 44A, and are attracted or repelled by the electromagnetic field created by energizing the stacked stator coils. As a result, the rotor 44 moves vertically along a sliding sleeve 48. Supplying current to the stator coils and precisely timing that current based on a location of the rotor causes the rotor to move upward or downward along the sliding sleeve. Additionally, by timing energizing of the stator coils 42 and the direction of current flow through the coils, relative to a position of the permanent magnets, one or more of the coils can produce attractive or repulsive forces.

For example, when a permanent magnet is located slightly below a first coil, energizing that first coil with current flowing in the proper direction relative to the polarity of the permanent magnet, attracts the permanent magnet. If that same permanent magnet is slightly above a second coil, energizing that second coil with current flowing in the proper direction relative to the polarity of the permanent magnet results in a repulsive force between the permanent magnet and the second coil. Thus, the first coil attracts the magnet/piston upwardly while the second coil repels the permanent magnet to move upwardly, producing the push-pull effect.

Note also that all stator coils at a specific distance above a base of the cartridge or bayonet must be energized at the same time. Energization of the coils progresses up or down the stack to cause vertical movement of the rotor 44.

A threaded or bayonet fastener 56 maintains elements of the cartridge 40 in the correct orientation and relationship. The fastener may further include anti-rotation tangs (not specifically shown) to facilitate serviceable installation, i.e., to ensure that a replacement cartridge is not installed in an incorrect orientation.

The rotor 44 thus moves vertically along the sliding sleeve (as indicated by arrowhead 58); a movement similar to the vertical movement of a piston in an internal combustion engine. As is known by those skilled in the art the vertical movement of the piston is transferred to rotational movement of a crankshaft. The vertical movement of the rotor 44 is likewise transferred to rotational motion by virtue of a similar crankshaft, which is not illustrated in FIG. 2. Thus, the cartridge 40 is a suitable replacement for the piston of an internal combustion engine, but does not require fuel to operate. As explained, the rotor travels up and down along the sliding sleeve, much like a piston travels up and down within a cylinder of an internal combustion engine.

Further, the coils 42 can be “fired” (that is energized) multiple times to attract and/or repel the piston during its travel up and down the cylinder, thereby providing nearly continuous forces on the piston and more frequent torque impulses on the shaft. This is to be distinguished from an internal combustion engine that supplies a force (and thus torque) only once per a four stroke piston engine, that is, when the spark plug fires.

When considering an engine comprising several such cylinders of FIG. 2, various and different ones of the cartridges can be fired or energized (thereby supplying current to one or more of the stator coils to create attractive or repulsive forces) as desired to stagger dwell times (based on length of the firing pulse) and advanced or retarded timing to create a desired torque profile.

The present invention also can provide regenerative current as the permanent magnet moves relative to a stator coil. This current recharges the storage element 10 via a conductor 33 in FIG. 1, Note that in FIG. 2 the stator coils are disposed around the circumference of a cylinder and the permanent magnet rotor moves vertically along the stator coils. FIG. 3 illustrates a cross section of this embodiment wherein the coils of the stator 42 are disposed around a circumference and the permanent magnet rotor 44 (with the poles labeled N and S) moves vertically along the sliding sleeve 48. As known by those skilled in the art, the key point of the embodiment of FIGS. 2 and 3 is the interaction of the magnetic field created by coils and the magnetic field created by the permanent magnets. The key principle of operation relies on the interaction of the magnetic field created by the permanent magnet and the magnetic field created by the electromagnets, which interact according to Faraday's law.

The modularity of the inventive cartridge design provides advantages over conventional rotor/stator assemblies, including:
Serviceability: Replacement in minutes rather than complete motor replacement.
Thermal Management: Direct liquid cooling at the cartridge level.
Scalability: Ability to swap coil-based or permanent-magnet cartridges to match performance requirements.

### Rotary Internal Magnetic Engine

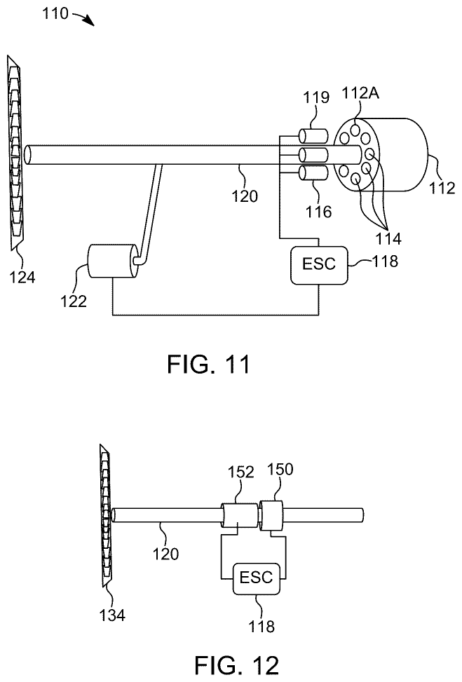

FIG. 11 illustrates a rotary embodiment 110 of the present invention, comprising a rotor 112 having a plurality of magnets 114 set in a surface 112A of the rotor. The magnets are disposed proximate a plurality of stator elements 116 and disposed circumferentially within the rotor. Current is supplied to the stator elements from an engine speed controller 118 in the form of a pulse width modulated timing signals that cause a significant current (from a battery for example) to be delivered to the stator coils, thereby creating a magnetic field that causes the rotor 112 to rotate about a center shaft 120. A starter/generator 122 provides the initial rotational forces to the center shaft 120, after which the rotating rotor drives the center shaft. In the illustrated embodiment, the center shaft drives a propulsor 124. As applied to the present invention the propulsor represents any element that needs to be driven in circular manner, such as a fan, propeller, vehicle wheels, or a turbine.

Conductive material in the form of a sleeve 119 is interposed between the stator elements and the enclosure in which they are located to provide structural alignment and thermal conduction.

In a preferred embodiment the starter/generator 122, mechanically coupled to the shaft 120 supplies start-up torque and harvests regenerative energy of the rotating shaft. The starter/generator also includes generating components for providing electrical power based on rotation of the rotating shaft 120. The engine speed controller 118 supplies current to the stator coils 116 based on an angle of the output shaft 120 and further controls a length of the energizing pulse (similar to a dwell time concept for an internal combustion engine) and also timing of the current pulse based on a location of the plurality of rotor magnets 114 relative to a location of the stator coils 116.

In operation, the ESC 118 (electronic speed controller) sequences energization of the stator coils 116 according to the angular position of the rotor 112 or the shaft 120. The resulting ignition-timed pulses generate discrete torque impulses that accelerate the shaft 120 and drive the propulsor 124. Unlike continuous commutation in conventional BLDC motors, the IME's brushless configuration applies high-peak, ignition-like pulses coordinated with rotor position, yielding torque curves similar to an internal combustion engine.

FIG. 12 illustrates a rotor 150 and stator 152 in operational proximate positions so that the magnetic field developed by the stator coils, as triggered by the ESC 118 causes rotation of the rotor. Otherwise, the FIG. 11 and FIG. 12 embodiments are operationally identical.

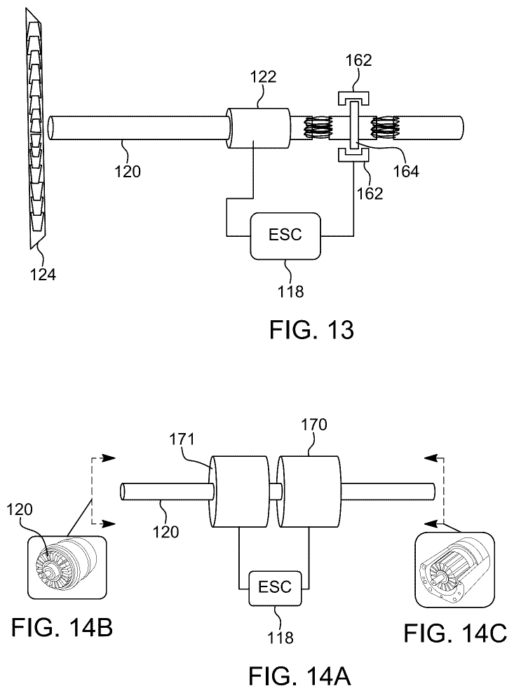

FIG. 13 illustrates another rotary brushless embodiment of the internal magnetic engine (IME), highlighting the relative positions and shapes of a stator 162 and a rotor 164. As can be seen, in this embodiment the disc-shaped rotor 164 rotates within the U-shaped stator 162.

As in the other embodiments, the center shaft 120 transmits torque to the propulsor 124.

Preferably, the rotor 164, mounted on the shaft 120, comprises permanent magnets. The stator 162 is positioned radially around the rotor and energized by the ESC 118.

The starter/generator 122 is also coupled to the shaft 120 to provide startup energy and regenerative capability.

Th ESC 118 provides ignition-timed energization of the stator coils via PWM signals.

In operation, the ESC 118 applies ignition-timed magnetic pulses to the stator 162. These pulses generate a magnetic field that interacts with the magnets of the rotor 164 to produce torque impulses on the shaft 120, which drives the propulsor 124. The rotor-stator geometry demonstrates how the configuration enables discrete, high-peak torque impulses, unlike the continuous commutation profile of conventional BLDC motors.

FIG. 14A illustrates a rotary brushless embodiment of the internal magnetic engine (IME) that is structurally similar to the FIG. 12 embodiment, except the external propulsor 134 is omitted for clarity.

The enter shaft 120 serves as the rotor, carrying embedded or mounted permanent magnets (not shown) along its length and passing through multiple stator assemblies. The stators 170 and 171 are disposed radially around the shaft 120 at spaced intervals. The stators comprise wound coils or modular cartridge assemblies as described elsewhere herein.

A starter/generator is not depicted but is mechanically coupled to the shaft 120, providing initial rotation and regenerative energy capture. See for example, the starter/generator 122 in FIG. 11.

The ESC 118 electronically governs energization of the stator coils with ignition-timed PWM signals as in other described embodiments.

FIG. 14B is a perspective view of the rotor 120, illustrating the placement of permanent magnets along the shaft.

FIG. 14C is a perspective view of the stator 170 or 171 illustrating the winding arrangement of the stationary coil assembly that surrounds the shaft 120.

In operation, the ESC 118 energizes the stators 170 and 171 at ignition-timed intervals. Magnetic interaction between the energized coils and the permanent magnets mounted on the rotor shaft 120 produces discrete torque impulses, which are transmitted through the shaft to drive an external load. The stator assemblies remain stationary relative to the rotating shaft, thereby defining the concentric rotor- stator geometry.

The starter/generator provides startup torque and regenerative capture.

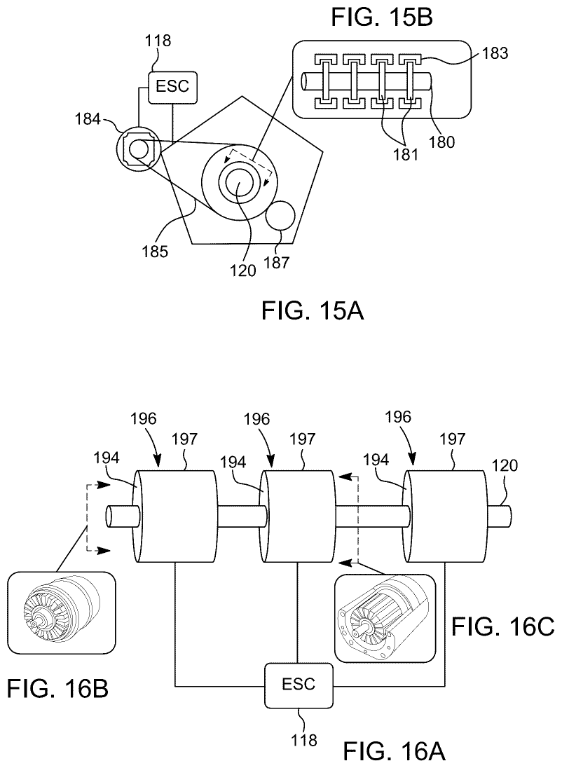

FIG. 15A illustrates yet another brushless embodiment of the internal magnetic engine (IME) incorporating a pulley-driven auxiliary system and a perspective FIG. 15B of the rotor-stator geometry.

The center shaft 120 transmits rotary motion to loads and auxiliary systems.

Rotor 180 is mounted to the shaft 120 and carries permanent magnets 181. See FIG. 15B

Stator 183 is disposed around the rotor, as shown in detail in FIG. 15B.

Generator/alternator 184 is mechanically coupled to the shaft 120 via a pulley wheel and belt 185, and functions as an auxiliary generator or regenerative energy capture device.

A starter 187 provides initial shaft rotation at startup.

The ESC 118 electronically sequences stator coil energization with PWM ignition timing.

In operation, ignition-timed pulses energize the stator 183, interacting with magnets of the rotor 180 to generate torque on the shaft 120. The pulley wheel and belt 185 transmits shaft power to generator/alternator 122, while the starter 187 provides initial rotation.

The inset cross-section of FIG. 15B illustrates the alternating geometry of rotors 180 and the stators 183.

This embodiment demonstrates how the rotary brushless IME may be integrated into existing mechanical architectures, using pulley-driven auxiliary devices in the same manner as conventional ICE engines, while still employing ignition-timed electromagnetic pulses rather than combustion.

FIG. 16A illustrates a multi-stage rotary brushless embodiment of the internal magnetic engine (IME). In this arrangement, multiple rotor-stator sections 190 are distributed along a common center shaft 120 to increase torque output and allow staged regeneration. This embodiment demonstrates the scalability of the rotary IME: additional rotor-stator stages may be added along the shaft to increase output while maintaining ignition-timed, pulse-based operation distinct from continuously commutated BLDC motors.

The center shaft 120 transmits torque from multiple rotor-stator stages to an external load.

Rotors 194 (three depicted with one rotor embedded in each multi-stage unit 196) in one embodiment comprises a permanent-magnet rotor mounted along the shaft and shown at multiple positions on the shaft 120.

A stator 197 is positioned around each rotor 194.

A starter/generator (not shown) is coupled to the shaft 120 to supply startup torque or capture regenerative energy.

The ESC 118 coordinates energization of the multiple stator assemblies, delivering ignition-timed pulses via PWM signals.

In operation, each rotor-stator pair 196 contributes a torque impulse to the center shaft 120. The ESC 118 sequences or staggers energization across the multiple stages, enabling smoother torque delivery, increased power density, or selective regeneration. Generating successive high-peak impulses produce smoother torque delivery, increased aggregate output, and staged regenerative capability. The starter/generator may also recover regenerative energy from one or more stages.

FIGS. 16B and 16C provide perspective views of the rotor and stator constructions. FIG. 16B illustrates the rotor section, including the permanent magnets mounted to the shaft. FIG. 16C illustrates the stator section, showing the coil winding or cartridge arrangement surrounding the rotor shaft.

### Ignition-Timed Magnetic Impulse Engine (Linear or Rotary)

In certain embodiments, the internal magnetic engine (IME) departs from continuous commutation as used in brushless direct-current (BLDC) motors by applying discrete, high-peak magnetic pulses to the stator coils. These pulses are timed to the angular position of an output shaft or equivalent movable member, as determined by a position sensor, such as an encoder or resolver. The timing control unit 30 of FIG. 1 governs application of the pulses according to timing maps that specify dwell (pulse width), advance/retard angle, and per-cycle phasing. This control produces torque characteristics analogous to an internal combustion engine ignition map, rather than the smooth torque profile of a BLDC motor.

Dwell (pulse width): This parameter corresponds to the commanded on-time of a cartridge coil 42 of FIG. 2. Longer dwell increases impulse energy; shorter dwell decreases impulse energy.

Advance/retard: This parameter corresponds to the relative position of the leading edge of the coil's excitation pulse with respect to the shaft torque angle. Applying the magnetic field too early, before the mover enters the coil's region of maximum coupling, or too late, after the mover has passed, reduces net torque.

Per cycle phasing: The timing controller schedules firing of multiple cartridges 40 within a mechanical cycle. Cartridges may be actuated every 360°, at sub −360° intervals, or in staggered firing orders across four cartridges/coils. Timing may be distributed across cartridges during an engine revolution to produce smoother torque output.

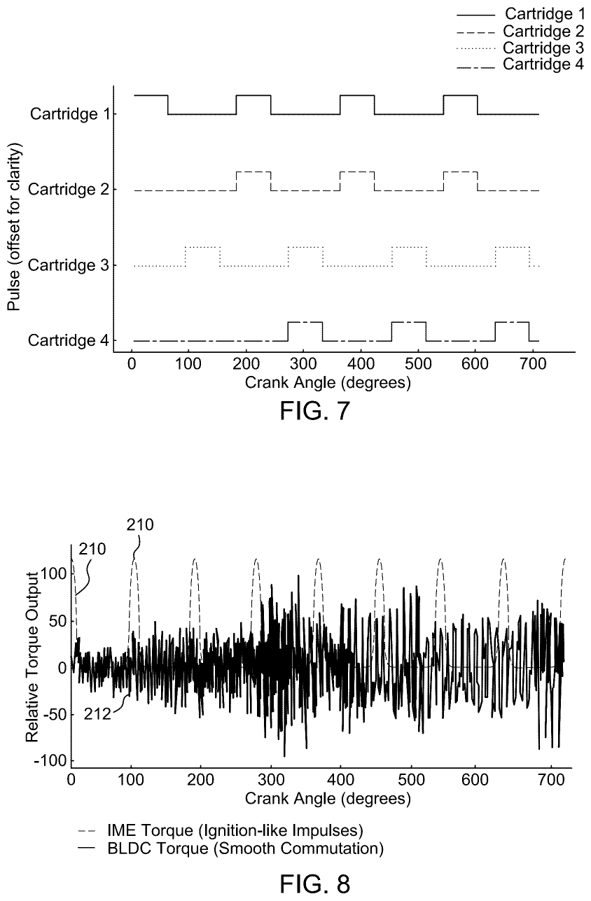

FIG. 7 illustrates a representative timing map including: (i) pulse width (dwell periods), (ii) firing angle with advance markers at 30° and 390°, and (iii) a firing order for four cartridges staggered every 180° with approximately 60° duration each.

Because the impulses are discrete and timed to torque angle, the IME generates “engine-like” torque curves. Torque output rises and falls with load and timing, in contrast to the continuous commutation profile of BLDC machines. FIG. 8 provides a conceptual comparison between IME ignition-like impulse trains 210 and BLDC commutation 212, illustrating the distinct torque output profiles.

A key feature of the IME of the present invention is the serviceable stator-plug cartridge modules; reference character 40 of FIG. 2.

In certain embodiments, each working zone of the internal magnetic engine (IME) comprises a modular, replaceable cartridge 40 that is installed at a cylinder head (linear configuration) or around a rotor ring (rotary configuration). Unlike conventional sealed motor stators, these cartridges are designed to be field-serviceable in a manner analogous to spark plugs in internal combustion engines.

Each cartridge may incorporate:
A ferrite-backed copper coil or a permanent magnet core (rotor), the latter illustrated in FIG. 2. Other magnetic material may be used in lieu of ferrite.
A conductive thermal pad or sleeve 76 (see FIG. 2) positioned between the plurality of coils 42 and a cartridge housing or enclosure 78. This thermal path transfers heat from stator coils directly to a liquid jacket 80 surrounding each cartridge.
A sealing element such as an O-ring, copper seal, or gasket 79 is located on an upper surface of the cartridge to prevent coolant or pressure leakage during operation. See FIG. 2.
Quick-disconnect coolant ports for liquid-jacket cooling 80A and 80B (see FIG. 2) are integrated with the cartridge collar. The ports include self-sealing check valves so that when the cartridge is removed, coolant does not leak out from the cartridge coolant system.

The cartridges are configured for rapid removal and replacement, thereby supporting high-duty cycle operation and minimizing downtime.

Both of the following embodiments are acceptable: permanent magnets on the rotor with electromagnetic coils in the cartridges (as in FIG. 2) or electromagnetic rotor elements 52 interacting with stator permanent-magnets 51 disposed around the circumference of the cartridge. See FIG. 4. The IME of the present invention is flexible so long as the permanent magnet (rotor or stator) interacts with the field created by electromagnets (stator or rotor). FIG. 5 illustrates a rotor 49 and a stator 50, while FIG. 6 illustrates a rotor 54 and a stator 53.

The procedural sequence for removing and replacing a cartridge module 40 includes: (i) disconnecting coolant ports 80A/80B, (ii) loosening the bayonet fastener 56, (iii) extracting the spent cartridge, and (iv) inserting a replacement cartridge and reseating the seal 78.

### Push-pull Opposed Coil Stroke With Per-stroke Energy Regeneration

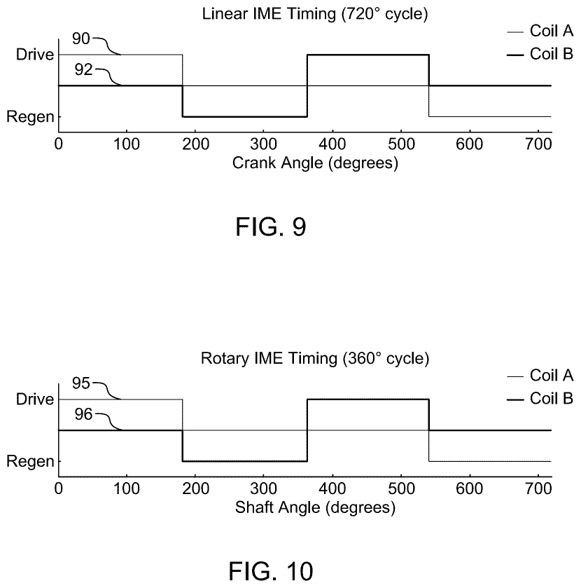

FIG. 9 (Linear IME Timing—720° cycle) illustrates a timing diagram for a linear internal magnetic engine cycle over 720 degrees of rotation. A first coil (coil A) represented by timing line 90, drives the forward stroke to provide forward propulsion during this power stroke, while an opposed Coil B (represented by timing line 92) operates in a regenerative mode during the return stroke.

FIG. 10 (Rotary IME Timing—360° cycle): Timing sequences demonstrate alternating drive and regeneration between opposed coils, mapped to shaft angle. Alternating coils (timing lines 95, 96) provide opposed push-pull forces, with one coil delivering drive torque while the other either assists with the return stroke or operates in regenerative mode.

In certain embodiments, the internal magnetic engine (IME) employs opposed coil stator pairs positioned on either side of the movable magnetic element (rotor). This arrangement enables propulsion in one direction while simultaneously allowing energy recovery during the return stroke.

In one embodiment, Coil A is energized to generate a forward propulsion stroke. See timing curve 90 in FIG. 9.

In the same cycle, Coil B may be operated in one of two selectable modes:
Active return mode—Coil B is energized to provide an active restoring force on the movable element; See curve 92; or
Regenerative mode—Coil B is electrically back-biased through a rectifier, H-bridge, or equivalent switching network such that kinetic energy of the returning movable element is harvested as current into a DC link (generator operation).

A timing control unit 30 of FIG. 1 determines the operating mode of Coil B on a per-stroke basis according to shaft angle, load conditions, or thermal duty cycle. A mechanical bobweight or counterbalance may further smooth the reciprocating motion of the IME into continuous rotary output.

This push-pull architecture differs from conventional motors, in which coils are continuously commutated without per-stroke regeneration. By contrast, the IME enables each stroke of motion to be either: (i) productive in generating forward torque, or (ii) productive in harvesting return energy, thereby improving overall system efficiency.

### Integrated Energy Manager

FIG. 1 further illustrates an integrated energy manager 31 receiving electrical output data from alternator or generator 16 and feedback from the sensors 24, including cartridge-temperature and shaft-angle data.

The energy manager dynamically apportions power among ignition pulses to electromagnetic coils 42 of the IME 12, the storage element 10, and external load 20, while enforcing thermal duty-cycle limits.

The energy manager is configured to dynamically allocate available electrical power among:
Ignition pulses—supplying the next sequence of timed cartridge firings to the stator coils 42 of FIG. 2 via the alternator or generator 16 of FIG. 1;
Energy storage—charging a battery, capacitor, or equivalent storage medium such as the storage element 10 of FIG. 1 via the alternator/generator 16 of FIG. 1; and
External loads—providing usable power to auxiliary devices or external systems, such as the load 20 illustrated in FIG. 1.

The energy manager operates in coordination with shaft-angle feedback (as determined by sensors 24, see FIG. 1) and thermal duty-cycle constraints

The energy manager operates in coordination with shaft-angle feedback (as determined by sensors 24, see FIG. 1) and thermal duty-cycle constraints derived from cartridge temperature sensors. These thermal inputs allow the controller to limit maximum duty cycles by reducing dwell time or staggering ignition pulses, thereby maintaining stable shaft speed and preventing overheating of the cartridges 40 (FIG. 2).

To maintain stable shaft speed and prevent overheating of the cartridges 40 (FIG. 2) Allocation ratios may be adjusted in real time according to load demand and operating temperature.

In one embodiment, the energy manager 31 (FIG. 1) prioritizes sustaining shaft rotation under load while diverting excess power to storage and loads. In another embodiment, the controller applies thermal constraints to limit maximum cartridge duty cycles, reducing dwell or delaying ignition pulses to prevent overheating.

The system is not a perpetual motion machine. Operation requires input energy from primary or secondary sources, and system efficiency is bounded by physical laws. Losses occur in the form of copper resistive heating, core losses, switching and rectification losses, mechanical bearing friction, and pump or fan power draw. Accordingly, the IME functions within the constraints of:
The First Law of Thermodynamics (conservation of energy)
The Second Law of Thermodynamics (entropy increase)

### Primary/Secondary Source Architecture

In certain embodiments, the internal magnetic engine (IME) operates using a primary energy source while selectively blending a secondary energy source to sustain operation and optimize performance.

In one embodiment, the primary source comprises an energy storage element such as a battery, capacitor, or equivalent device. See storage element 10 in FIG. 1. In another embodiment, the secondary source comprises a permanent-magnet generator (PMG) mechanically coupled to the engine shaft, or an alternative renewable input. See element 16 (alternator or generator) in FIG. 1.

A power regulation system, which may include a Maximum Power Point Tracking (MPPT) controller, is configured to maintain the secondary source at its optimal operating conditions.

In certain embodiments, the MPPT controller also functions as a substitute for a dedicated voltage regulator, particularly where the generator lacks integrated regulation.

Generally, the alternator/generator 16 is the primary source of electrical power during normal operation. The storage element 10 functions as the secondary source, serving as a buffer and providing starter energy. The controller blends these inputs to maintain stable shaft speed and continuous ignition under varying load conditions.

The system controller (timing control unit 30 of FIG. 1) manages blending of the primary and secondary sources in coordination with ignition timing, such that:
Power delivery to the cartridges 40 (see FIG. 1) is maintained under varying loads;
Shaft speed stability is preserved (that is, the main output shaft 14 of the IME 12, see FIG. 1). The shaft 14 is the rotating member whose speed stability is managed by blending the primary source (alternator/generator 16) and the secondary source (storage element 10).
Excess secondary-source energy may be diverted to storage or external loads.

This architecture allows the IME to exhibit engine-like behavior, dynamically adapting to changing load conditions while coordinating multiple energy sources in real time.

### Working Medium Options

In certain embodiments, the magnetic field serves as the working medium for the internal magnetic engine (IME).

In one embodiment, the working medium is generated electromagnetically by energizing a coil within the serviceable cartridge module.

In another embodiment, the working medium is provided by a high-strength permanent magnet cartridge, which may be replaceable after a defined service interval. Note that the IME 12 can employ either electromagnets, permanent magnets, or a combination thereof depending on the embodiment:

In one embodiment, the electromagnetic coil within the serviceable cartridge provides the working medium, generating timed, controllable magnetic fields.

In another embodiment, a permanent magnet insert or cartridge (such as illustrated in FIG. 2) provides a baseline magnetic field, which can be augmented or modulated by the coil pulses.

In yet another embodiment, both are combined: the permanent magnet establishes a constant bias field, while the coil provides the controllable, impulsive component. This hybrid approach enhances force density, reduces coil power draw, and enables fine-tuned control while still supporting replaceable cartridge serviceability.

Unlike conventional BLDC (brushless DC motors) or AC drives, in which phase currents are sequenced nearly continuously around the stator to produce smooth commutation, the IME applies discrete magnetic impulses at predefined torque angles. This ignition-timed operation produces engine-like torque characteristics while allowing cartridge modularity and per-stroke energy recovery.

### Geometry: Linear Vs. Rotary Configurations

In certain embodiments, the internal magnetic engine (IME) may be implemented in either a linear configuration or a rotary configuration, each employing ignition-timed control of energizing the electromagnets.

Linear configuration: In one embodiment, the engine includes reciprocating pistons coupled to a crankshaft. See FIG. 2. The pistons are actuated by magnetic impulses scheduled in a manner similar to internal combustion engine firing orders, but without being constrained to traditional 720° (four-stroke) or 360°(two-stroke) cycles. Magnetic ignition pulses may occur every 360°, or at sub −360° intervals, thereby enabling more frequent torque impulses at reduced per-stroke energy.

Rotary configuration: In another embodiment, (see FIG. 11-16 the engine includes a rotor surrounded by stator-plug cartridges arranged circumferentially. Each cartridge is fired at calibrated torque angles, producing impulsive torque delivery rather than continuous commutation.

Both configurations utilize the serviceable cartridge modules described above and share the ignition-timed control philosophy of the IME.

FIG. 7 illustrates a representative timing map applicable to both linear and rotary embodiments, including:
dwell duration versus current rise,
firing advance relative to torque angle, and
per-cycle firing patterns across multiple cartridges.

The traces of FIG. 7 also demonstrate thermal duty-cycle limits that constrain maximum dwell at elevated RPM and load conditions.

For several reasons, the present invention is not considered an obvious aggregation of known elements (motor and generator, for example) nor is it considered an obvious variant of an ICE. The internal magnetic engine (IME) constitutes a distinct engine topology whose novelty derives from the synergistic combination of:
ignition-timed magnetic impulses,
replaceable cartridge modules with integrated cooling,
opposed push-pull coils configured for per-stroke regeneration, and
coordinated energy apportionment among ignition, storage, and external loads.

The cross-sectional view of FIG. 2 (also discussed above) illustrates the coils 42, permanent magnet 44A/44B, cartridge housing 80, and integrated cooling jacket 76 with a coolant flow path out from valves 80A and 80B.

Specifically, (with reference to FIG. 2):
electromagnetic coils 42 disposed circumferentially within the cartridge housing 78;
permanent magnet inserts 44A/44B are mounted to the piston-like element 44;
the sliding sleeve 48 guides reciprocating motion of the piston-like element 44;
the thermal pad 76 positioned between the coils 42 and the housing 78 transfer heat;
the sealing element 79 (e.g., gasket or O-ring) prevents leakage of coolant or pressure;
the integrated liquid cooling jacket 80 with coolant ports 80A and 80B for circulation of coolant;
a bayonet fastener 56 secures the cartridge 40 within an engine head or housing;
an electrical connector 82 supplies energizing current to the coils 42; and
shaft interface 51 for mechanically linking the cartridge piston-like element 44 to a piston rod of the linear motor.

In operation, the piston-like element 44 reciprocates along the sleeve 48 under influence of magnetic forces generated between the coils 42 and the permanent magnets 44B. The shaft interface 51 transfers this reciprocating motion to the piston rod of a conventional engine, thereby converting linear motion into crankshaft rotation. The electrical connector 82 enables serviceable electrical engagement and disengagement of the cartridge, while the bayonet fastener allows rapid removal and replacement. The cooling ports 80A and 80B permit liquid coolant to circulate through the cartridge housing 78, dissipating heat from the energized coils 42.

In certain embodiments, the cartridge design provides a serviceable and thermally managed interface not taught or suggested by conventional sealed motors. Timing maps permit magnetic ignition at intervals shorter than 720° of crankshaft rotation, thereby enabling more frequent torque impulses and higher efficiency than internal combustion engines.

This coordinated system differs materially from prior art BLDC motors, which rely on continuous commutation, and from simple motor-generator couplings, which do not employ cartridge-based ignition timing, per-stroke regenerative capture, or engine-level energy management.

The IME requires input energy and operates within the bounds of physical laws, including conservation of energy and entropy increase. Losses due to electrical resistance, switching, magnetic core effects, and mechanical friction preclude perpetual motion.

To summarize, in a preferred embodiment, the invention provides an engine topology in which ignition-timed magnetic impulse cartridges drive either linear or rotary mechanics. The engine employs opposed-coil push-pull strokes with selectable per-stroke regeneration, bobweight balancing, and a power manager configured to partition generator output among storage, ignition pulses, and external loads. The magnetic field serves as the working medium, which may be generated either by an energized electromagnetic coil or by a replaceable permanent-magnet cartridge.

Note that the IME of the present invention can function with either type of magnetic working medium—an energized electromagnetic coil or a replaceable permanent-magnet cartridge—depending on the embodiment. However, in a preferred embodiment the system employs both in combination: the permanent magnet establishes a baseline bias field while the electromagnetic coil provides the timed, impulsive component. This hybrid approach improves efficiency, reduces coil power draw, and enables more precise control.

Torque impulses are not constrained to traditional internal combustion engine cycles and may be scheduled at intervals shorter than 720° of crankshaft rotation.

Note that the timing signals output from the timing control unit 30 do not have sufficient current to create proper energizing signals for the electromagnets 42 of FIG. 2. The storage element 10 can be viewed as the IME's equivalent of an ignition engine coilpack. In a combustion engine, the coilpack stores electrical energy and then releases it as a high-voltage pulse to fire the spark plug at the correct time. In the IME, the storage element 10 performs a very similar role: storing electrical energy and then discharging it as a high-current pulse into the cartridge coil when commanded by the control unit.

Specifically, the CPU/ESC (engine speed control within the timing control unit 30 of FIG. 1) signals from the timing control unit 30 are in fact the PWM timing signals, which trigger the driver electronics to release the capacitor's stored energy. This separation of functions ensures:
CPU/ESC: precise timing and pulse width control,
Driver stage within the control unit: current switching devices to handle current flow,
Storage element 10: energy storage and rapid release, analogous to an ICE coil pack.

This way, the IME achieves the same ignition-style coordination as a conventional engine, but with magnetic impulses instead of sparks.

What is claimed is:

1. An engine comprising:
a movable member coupled to an output shaft, wherein the moveable member is displaced responsive to a magnetic field and thereby causes rotation of the output shaft;
a plurality of replaceable cartridge modules each comprising a plurality of coils for generating the magnetic field responsive to energization and each comprising a moveable member;
a sensor configured to provide an output shaft angle;
a timing controller configured to energize each coil within each one of the plurality of cartridge modules responsive to one or both of the output shaft angle and an external load, wherein energizing each coil generates the magnetic field at predetermined angular positions of the output shaft;
a generator or alternator mechanically coupled to the output shaft for generating an electrical output; and
a power manager configured to partition the electrical output among an energy storage device, an external load, and energization of the plurality of coils.

2. The engine of claim 1, wherein the moveable member moves vertically responsive to the magnetic field, and wherein vertical movement causes rotation of the output shaft.

3. The engine of claim 1, wherein the plurality of coils are disposed vertically inside an enclosure and the moveable member moves vertically within the enclosure responsive to the magnetic field.

4. The engine of claim 1, wherein the plurality of coils are disposed along an inside surface of a cylindrical enclosure, and wherein the moveable member is disposed within the cylindrical enclosure such that the moveable member rotates responsive to the magnetic field produced by the plurality of coils.

5. The engine of claim 1, wherein the plurality of cartridge modules comprises a first and a second cartridge module, wherein the plurality of coils of the first cartridge module and the plurality of coils of the second cartridge are energized at different times.

6. The engine of claim 1, wherein the moveable member moves vertically, and wherein certain ones of the plurality of coils within a first replaceable cartridge are energized to move the moveable member upwardly and other certain ones of the plurality of coils within the first replaceable cartridge are energized to move the moveable member downwardly.

7. The engine of claim 1, wherein the moveable member further comprises a plurality of permanent magnets, wherein an electromagnetic field generated by the plurality of coils interacts with a magnetic field generated by the plurality of permanent magnets to cause rotation of the output shaft.

8. The engine of claim 7, wherein motion of the moveable member generates a voltage within one or more of the plurality of coils, and wherein the voltage is supplied to one or more of the energy storage device and the external load.

9. The engine of claim 1, wherein the plurality of coils are energized at intervals shorter than 720°of output shaft rotation.

10. The engine of claim 1, wherein the energy storage device comprises a battery or a capacitor.

11. The engine of claim 1, wherein the power manager is further configured to dynamically apportion the electrical output in real time based on an output shaft angle, load demand, and thermal duty-cycle constraints of the plurality of cartridge modules.

12. The engine of claim 1, wherein each one of the plurality of replaceable cartridge modules comprises a ferrite-backed copper coil core, a thermal interface, a sealing element, and quick-disconnect coolant ports.

13. The engine of claim 1, wherein the timing controller is configured to adjust advance and dwell of energization of the plurality of coils relative to the output shaft angle according to a predefined timing map.

14. The engine of claim 1, wherein the plurality of coils are configured such that a first coil drives a forward stroke of the movable member and a second coil operates in a regenerative mode to harvest return-stroke energy.

15. The engine of claim 1, wherein the power manager is further configured to partition the electrical output between a primary source comprising the energy storage device and a secondary source comprising a permanent-magnet generator, the partition regulated by a maximum power point tracking controller to maintain generator efficiency and stabilize the energy storage device.

16. The engine of claim 1, wherein the movable member comprises: (i) a reciprocating piston coupled to a crankshaft in a linear configuration or (ii) a rotor surrounded by circumferential cartridge modules in a rotary configuration, in each configuration the timing controller configured to energize each coil within each one of the plurality of cartridge modules.

17. The engine of claim 1, wherein a working medium comprises: (i) an electromagnetic field generated by an energized coil of the plurality of coils or (ii) a magnetic field generated by a permanent magnet within each cartridge of the plurality of cartridges.

18. The engine of claim 1, wherein each one of the plurality of replaceable cartridge modules further comprises a threaded or bayonet coupling to facilitate rapid removal and replacement.

19. The engine of claim 1, further comprising a starter for displacing the moveable member before the magnetic field is produced to displace the moveable member.

20. An engine comprising:
a housing;
an output shaft disposed within the housing and comprising permanent magnets for producing a first magnetic field;
a plurality of replaceable cartridge modules disposed around a circumference of the housing, each comprising a plurality of coils for generating a second magnetic field responsive to energization;
a sensor configured to provide an output shaft angle;
a timing controller configured to energize each coil within each one of the plurality of cartridge modules responsive to one or both of the output shaft angle and an external load, wherein energizing each coil for generating the second magnetic field at predetermined angular positions of the output shaft;
a generator or alternator mechanically coupled to the output shaft for generating an electrical output; and
a power manager configured to partition the electrical output among an energy storage device, an external load, and energization of the plurality of coils.
